(19) United States
(12) Patent Application Publication
(10) Pub. No.: US 2007/0246323 A1
(43) Pub. Date: Oct. 25, 2007

(54) Load Torque Blocking Device

(75) Inventors: Ingo Drewe, Buehl (DE); Guido Schneider, Witten (DE)

Correspondence Address: MICHAEL J. STRIKER, 103 EAST NECK ROAD, HUNTINGTON, NY, 11743, US

(73) Assignee: ROBERT BOSCH GMBH, Stuttgart (DE)

(21) Appl. No.: 11/572,121

(22) PCT Filed: Aug. 15, 2005
(86) PCT No.: PCT/EP05/54005

§ 371 Date: Jan. 15, 2007

(30) Foreign Application Priority Data
Oct. 14, 2004 (DE) 10 2004 050 043.6

(51) Int. Cl. F16D 59/02; F16D 41/10

(52) U.S. Cl. 192/223.1; 192/144

(57) ABSTRACT

The invention relates to a load torque lock (10) for independently locking load-side torques during the drop or cessation of a drive-side torque, comprising a frame-fixed housing (11), an input shaft (12) that, together with engaging means (28), projects inside a housing borehole (18), and comprising an output shaft (13) that, together with an axially protruding extension (19), projects in a chord-like manner into the housing borehole (18). The load torque lock also comprises two clamping bodies (14), which are adjacently arranged inside the housing borehole, which are driven by the engaging means of the input shaft (12) together with the extension (19) of the output shaft, and which are pressed and clamped tightly by the extension (19) of the output shaft against the inside wall (18a) of the housing borehole. In order to achieve a high-performance, low-noise load torque lock, the engaging means (28) are provided in the form of two eccentrically arranged projections, which each project into an opening (27) of a clamping body (14) whose opening width (W) is greater than the thickness (D) of the projections (28).

### RELATED ART

The present invention relates to a load torque blocking device for automatically blocking load-side torques, according to the preamble of claim 1.

The large number of known load torque blocking devices includes a group in which the physical blocking effect is based on a clamping or tilting principle, and it is not important that the principle be clearly definable as either clamping or tilting.

Within this group, it is known from U.S. Pat. No. 6,229,233 B1 to locate several clamping rollers on the circumference of a frame-mounted drum of a load blocking clutch, which are moved by a drive part into a neutral position and, when a load torque is produced that exceeds the drive torque, they are pressed by the ramps of a driven part against the wall of the drum. In that position, they create a jam between the driven part and the drum, thereby enabling the clutch to block load torques of this type. When the clamping rollers are in the neutral position, they are located loosely between the driven part and the housing during normal operation, and they are held axially only by a spring. As such, they often produce undesired noises during normal operation.

Furthermore, publication WO 03/054409 makes known a load torque blocking device, with which several clamping bolts bear against both sides of a frame-mounted blocking ring wall. The clamping bolts are displaceable via a blocking disk using drive means or driven means such that, when driven-side torque is produced, they tilt against the blocking ring walls and block the rotational motion. When drive-side torque is produced, they disengage from the blocking ring walls. Since the clamping bolts are located on a relatively large radius beyond the drive and driven shafts—which are aligned with each other—on the blocking ring wall that is enclosed by a housing, a large installation space is required for this system; this can be problematic, particularly in terms of vehicle design.

The aim of the present invention is to develop a system that fulfills all of the original objectives of a load torque blocking device, only some of which are performed more or less well by the known systems. The objectives include a high state of blocking readiness, a favorable relationship between the blockable torque and the amount of installation space required, and minimal power loss when the drive-side driving force occurs in either direction of rotation. A further objective is to realize a load torque blocking device that is also particularly quiet-running and therefore reduces the noises that are produced when the driving force occurs on the drive side.

### ADVANTAGES OF THE INVENTION

The inventive load torque blocking device with the features listed in the characterizing part of claim 1 has the advantage that it enables realization of a particularly compact design given that the engaging means of the drive shaft extend axially into the central openings of the clamping bodies. A further advantage of the inventive solution is that the compact design and the arrangement of the clamping bodies in the center of the load torque blocking device largely prevents centrifugal forces from acting on the clamping bodies. As a result, such a means of attaining the object of the invention can also be used preferably for fast-running drives, e.g., electric motors, to drive displacement systems that include components that move back and forth.

Advantageous refinements and improvements of the features indicated in claim 1 are made possible by the measures listed in the subclaims. To attain a design with the shortest possible axial length, it is advantageous to design the clamping bodies as clamping rings, into the through-holes of each which one of the two projections of the drive shaft extends with rotational angular play.

To attain the best possible blocking of load torques despite the compact design, it is provided in a refinement of the present invention that the inner wall of the housing opening and the outer wall of the two clamping rings both have two adjacently located, conically extending clamping surfaces that are positioned relative to each other in the shape of a V. As a result, the clamping rings are pressed against the inner wall of the frame-mounted housing in a wedge-like manner, thereby allowing high load torques to also be absorbed by the housing without deforming the housing. To ensure that the clamping that occurs on all clamping surfaces is as uniform as possible, it is advantageous to separate the V-shape-positioned clamping surfaces from each other using a cylindrical surface shell. Since these cylindrical surface shells are not clamping surfaces, they can be used for other purposes. It is particularly advantageous, for example, to provide the clamping rings with a groove-shaped recess on the outer circumference, in the region of their cylindrical surface shell, into which a leg of the two-legged spring element inserted between the extension of the driven shaft and the clamping rings engages. The recess is dimensioned such that the leg of the spring element is located therein with no radial overhang. This means of attaining the object of the present invention has the additional advantage that the power produced by high lock-up torques flows exclusively over the V-shape-positioned clamping surfaces or over the cylindrical surface shells, thereby decoupling the spring element from this power flow. At the same time, however, the spring force of the legs continues to act on both clamping rings. It is therefore ensured that the clamping rings are ready to perform blocking in any operating state.

Since the driven shaft extends, via an axially protruding extension, into the housing opening in a chord-like manner in the circumferential region of the housing opening, and it is operatively connected there with the clamping rings, it is provided, in order to minimize imbalance, that at least one axial through-hole—and, preferably, several adjacently located through-holes—is provided in this extension of the driven shaft. It is particularly advantageous to provide the central through-hole with a radially inwardly pointing opening in which an eyelet-shaped, central section of the spring element is displaceably accommodated.

Given that, according to the present invention, the peg-shaped projections of the drive shaft engage in the openings of the clamping bodies or clamping rings, empty installation space is attained in the housing of the load torque blocking device on the side of the two clamping rings that is diametrically opposite to the driven shaft extension. In a refinement of the present invention, this empty installation space can be used advantageously to loosely position a guide element in the housing opening, which bears against the inner wall of the housing opening and the outer walls of the two clamping rings. The guide element advantageously has a triangular contour, and it lies flat—via a convex outer side—against the inner wall of the housing, and flat—via two symmetrical, concave inner sides that point toward the housing center—against the outer surfaces of one of the two clamping rings. In this case as well, the convex outer side of the guide element is also advantageously provided with two V-shaped surfaces that are matched with the clamping surfaces of the inner wall of the housing, and with an intermediate, cylindrical section; the two concave inner sides of the guide element also have two V-shaped surfaces that are matched with the clamping surfaces of the clamping rings, with a cylindrical section located between them.

In a further embodiment of the present invention, the concave surfaces of the guide element extend past the region of the contact point of the clamping rings with each other, and they include, in this region, a connecting window, in which the two clamping rings bear against each other. The V-shaped positioning of the clamping surfaces and the outer sides of the guide element results in a compact design and an axial centering of the clamping rings and the guide element in the housing. As a result, additional axial, counter-rotational supports are not required. The system therefore has very little frictional loss when the driving force occurs on the drive side, and it has a high state of blocking readiness. In addition, due to the guide element, the movement of the clamping rings—which must take place when the driving force occurs on the drive side—is stabilized, thereby resulting in particularly smooth, low-noise operation. Furthermore, due to the proposed design and positioning of the spring element in the system, it is ensured that the spring element continues to introduce force in the center as desired in order to preload the clamping rings, even when vibrating accelerations occur.

### DRAWING

The present invention is explained below in greater detail, as an example, with reference to the attached drawing.

FIG. 1 shows a load torque blocking device with its individual parts, in the opened state and in a spacial depiction, as seen from the drive side,

FIG. 2 shows the same load torque blocking device with its individual parts, in a spacial depiction, as seen from the driven side,

FIGS. 3 and 4 show the assembled load torque blocking device in a spacial depiction, in a cut-away view,

FIG. 5 shows the load torque blocking device, in a top view, from the driven side,

FIG. 6 shows the load torque blocking device in a cross section along the line B-B in FIG. 5,

FIG. 7 shows a top view of the load torque blocking device along the cross section A-A in FIG. 8, in a neutral position,

FIG. 8 shows the load torque blocking device in a side view,

FIG. 9 shows a cross section of the load torque blocking device when the driving force occurs on the driven side and in the counterclockwise direction,

FIG. 10a shows the load torque blocking device while blocked in the clockwise direction,

FIG. 10b shows an enlarged section of FIG. 10a,

FIG. 10c shows the path of the force vectors that occur during blocking, and

FIG. 11 shows the load torque blocking device when the clamping rings are disengaged via a drive-side rotational motion in the counterclockwise direction.

### DETAILED DESCRIPTION OF THE EXEMPLARY EMBODIMENT

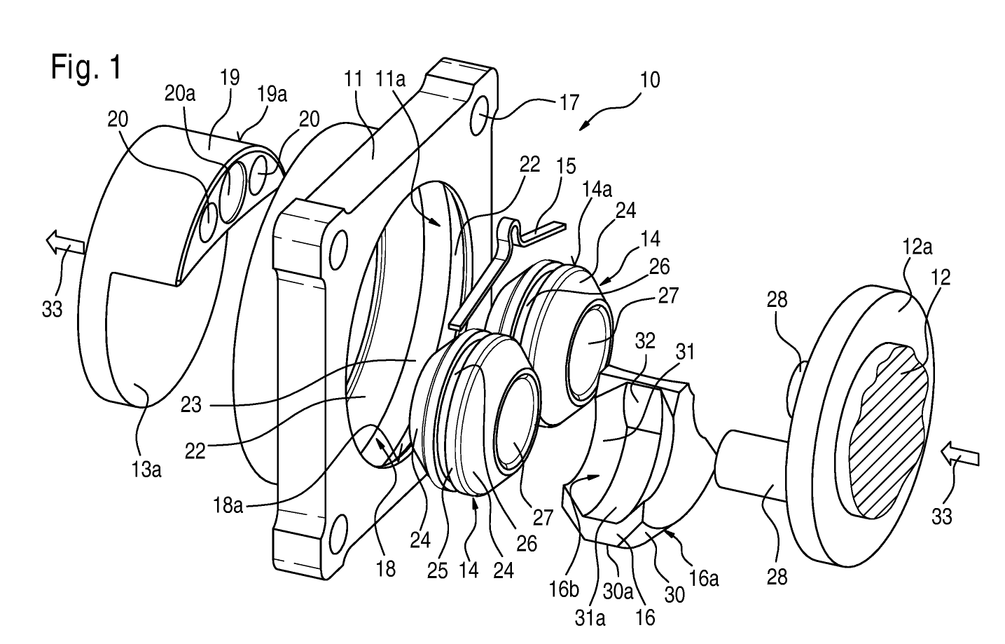

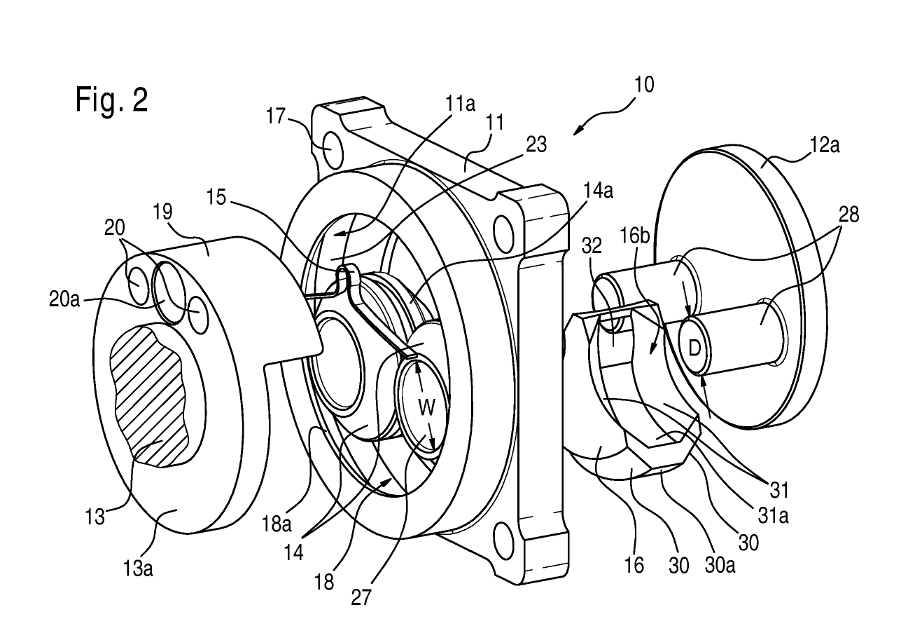

FIGS. 1 and 2 show a load torque blocking device 10 in the opened state with its exploded components, with a view of its drive side and its driven side. Load torque blocking device 10 is composed of a housing 11, a drive shaft 12, a driven shaft 13, two clamping bodies designed as clamping rings 14, a spring element 15, and a guide element 16.

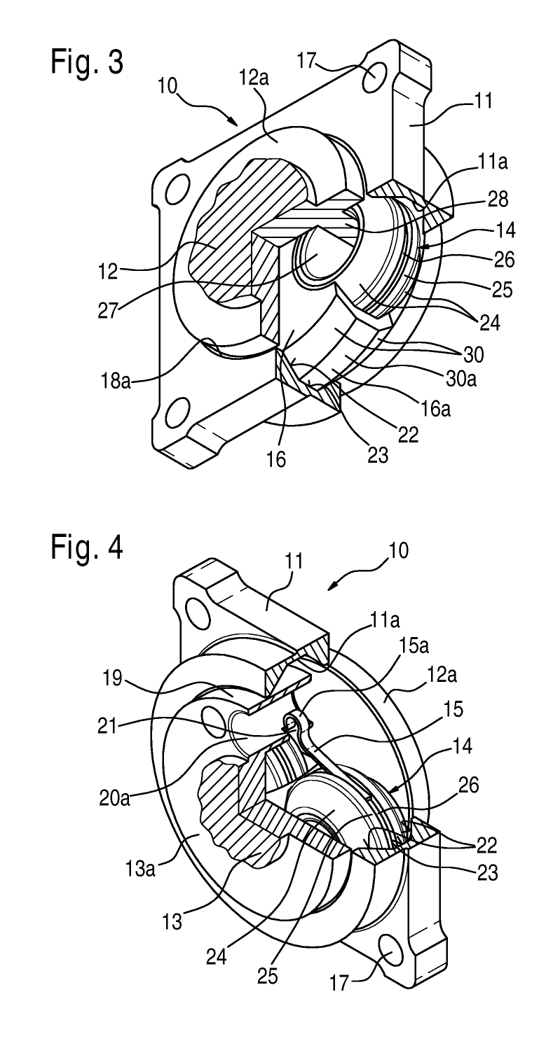

FIGS. 3 and 4 show load torque blocking device 10 in the assembled state with cut-away views of housing 11, drive shaft 12, and driven shaft 13, with a view of blocking rings 14, spring element 15, and guide element 16.

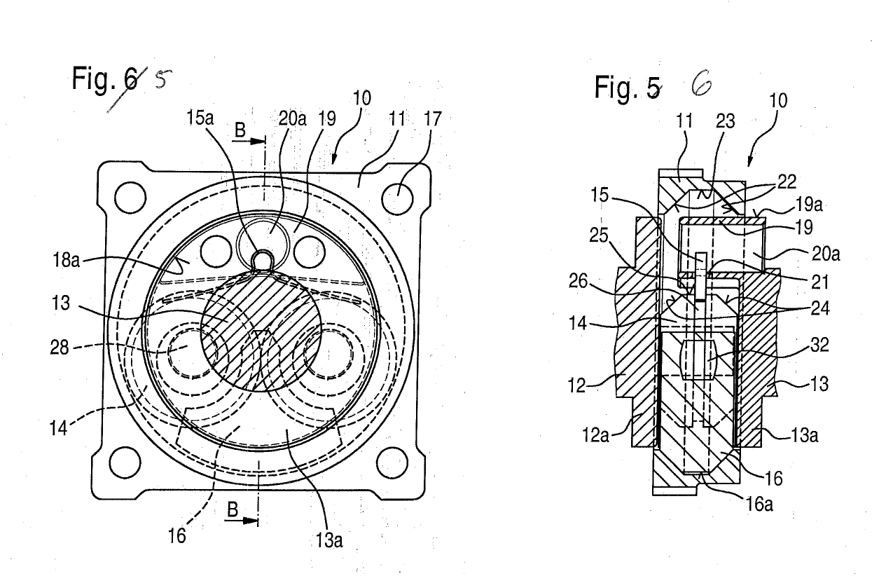

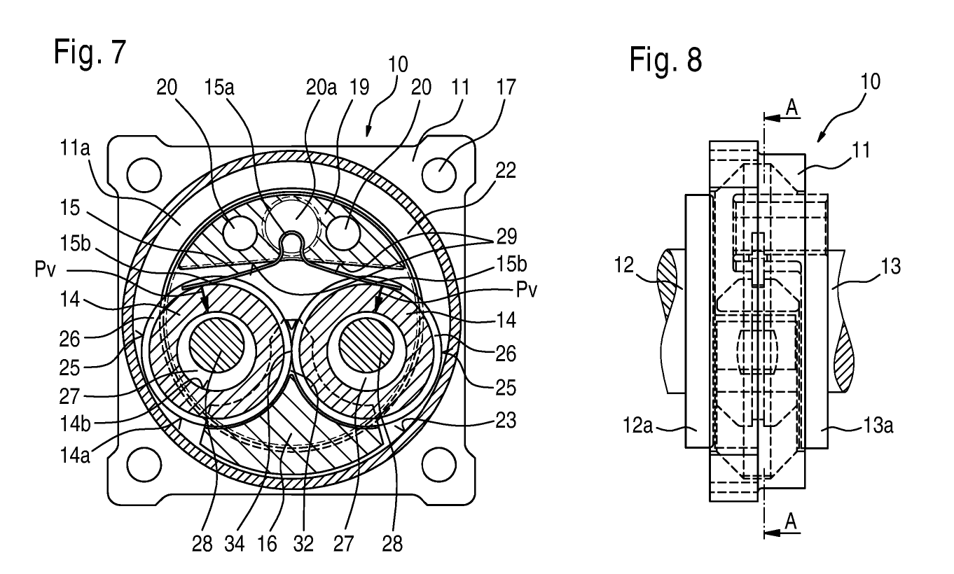

FIGS. 5 and 7 show the load torque blocking device in a front view from the driven side, and FIGS. 6 and 8 show the side views thereof. FIG. 6 shows a longitudinal cross section along the line B-B in FIG. 5, and FIG. 7 shows the front view in a cross section along line A-A in FIG. 8.

As shown in FIGS. 1 through 8, housing 10 is provided with fastening bores 17, via which housing 10 can be screwed tightly to a frame, e.g., in a motor vehicle. Housing 10 also has a continuous, centrally located housing borehole 18, into which a disk-shaped end section 12a—that is rotatably supported on a frame and is shown broken off—of a drive shaft 12 extends, on the drive side. On the driven side, a disk-shaped end section 13a of a driven shaft 13—that is also rotatably supported on the frame and is shown broken off—extends into circular housing opening 18. The drive shaft and the driven shaft are shown in simplified views and, depending on the application, typically include additional shaft sections or shaft connections that transfer the rotational motions and support the shaft. The drive shaft and the driven shaft are fixedly supported in the axial direction and therefore have freedoms of movement in both directions of rotation only around their geometric central axis. Driven shaft 13 also includes, on its end section 13a, an axially projecting extension 19 located on the circumference in a rotationally asymmetrical manner, which extends, in a chord-like manner, into housing opening 18 on the driven side in the circumferential region of housing opening 18. To offset the resultant imbalance, extension 19 of driven shaft 13 is provided with three adjacent through-holes 20 in order to shift the center of gravity of driven shaft 13 as close to the axis of rotation as possible. Through-holes 20 can also be used as supply chambers for a lubricant. Central through-hole 20a has a radially inwardly pointing opening 21, in which an eyelet-shaped, central section 15a of spring element 15 is snapped in place and is accommodated such that it can be displaced slightly.

The two clamping rings 14 are positioned eccentrically and adjacently in housing opening 18. They bear via their outer surfaces 14a against inner wall 18a of the housing opening and against each other. They are held in their neutral position depicted in FIG. 7 by spring element 15 that is inserted between extension 19 and clamping rings 14. In the interior of housing 11, inner wall 18a of housing opening 18 is provided with two annular clamping surfaces 22 that are positioned relative to each other in the shape of a V and therefore form a V-shaped annular groove 11a in housing 11. Clamping surfaces 22 are separated by a cylindrical surface shell 23. Outer wall 14a of the two clamping rings 14 is also adapted; it is provided with two axially adjadent, conically extending clamping surfaces 24 that interact with clamping surfaces 22 of housing 11 and are therefore positioned relative to each other accordingly, in the shape of a V. Clamping surfaces 24 are also separated by a cylindrical surface shell 25. In addition, each of the clamping rings 14 has a groove-shaped, circumferential recess 26 on the outer circumference, in the region of their cylindrical surface shell 25. Recess 26 is matched to the width and thickness of spring element 15 such that clasp-shaped spring element 15 can engage in the recess via its legs 15b with no radial overhand.

Each of the clamping rings 14 has an opening designed as a through-hole 27, into which an engaging means of drive shaft 13 extends axially. The engaging means of drive shaft 13 are formed by two peg-shaped projections 28 positioned eccentrically on the end face of drive shaft end section 12a, the diameter D of which is smaller than opening width W of through-holes 27 of clamping rings 14, and which do not touch clamping rings 14 when they are in the neutral position depicted in FIG. 7. Through-holes 27 of clamping rings 14 therefore form open space inside the clamping rings, into which a peg-shaped projection 28 of drive shaft 12 extends in the axial direction.

Extension 19 of driven shaft 13, which projects into housing opening 18, has a curved circumferential surface 19a on its outside that is matched to housing opening 18. On the inner side of extension 19, which faces the center of housing opening 18, a pressing surface 29 is provided for each of the two clamping rings 14, each of which can be brought to bear against a cylindrical surface shell 25 of a clamping ring 14.

Guide element 16 is located in the lower open space in housing opening 18 that remains in the circumferential direction between the two clamping rings 14. It has a triangular contour and bears via a convex outer side flatly against inner wall 18a of the housing. The outer side of guide element 16 is formed by two guide surfaces 30 that are positioned in the shape of a V and are matched via convex curvature with housing 11 such that they bear loosely against clamping surfaces 22 of housing 11, which have a matching convex curvature. The two concave, symmetrically positioned inner sides 16b—that point toward the center of the housing—also have two guide surfaces 31 that are also positioned in the shape of a V and have a concave curvature such that they bear flat and loosely against corresponding clamping surfaces 24 of clamping rings 14. Guide surfaces 30 and 31—that are situated in pairs and are positioned conically relative to each other—are also separated by an intermediate, cylindrical section 30a, 31a. Since triangular guide element 16 has a symmetrical design, the two clamping rings 14 are accommodated and guided in the same geometric shapes of guide element 16. Concave guide surfaces 31 of guide element 16 extend past the region of contact point 34 of clamping rings 14 with each other so far that regions of guide surfaces 31 and their cylindrical sections 31a intersect in the plane of symmetry of guide element 16 and form a connecting window 32 in this region, in which the two clamping rings 14 bear against each other. The contact between clamping rings 14 in the region of their cylindrical surface shell 25 that is required to block a load torque is therefore made possible. Guide element 16 therefore encloses regions of clamping rings 14 with slight clearance. Lubricant films can form in the resultant gaps between guide surfaces 30 and 31 of guide element 16 and clamping surfaces 22 and 24 of housing 11 and clamping rings 14 when grease is applied.

The mode of operation of load torque blocking device 10 will be explained in greater detail, below. FIG. 7 shows the neutral state of the torque blocking device. The neutral state exists whenever torque is not being applied to the drive shaft or the driven shaft. In this state, due to the spring force of spring element 15 on the ends of its legs 15b, a preload force Pv acts on recess 26 of cylindrical surface shell 25 of the two clamping rings 14 and presses clamping rings 14 against the V-shaped clamping surfaces of housing 11 in the position shown. Clamping rings 14 are also pressed against each other in the region of connecting window 32 in guide element 16. Their cylindrical surface shells 25 therefore touch at point 34. Spring element 15 therefore ensures that the system is always ready to block torque, in that it holds clamping rings 14—in any circumferential position—in contact with the parts adjacent to it. In this neutral state of the torque blocking device, the two peg-shaped projections 28 on end section 12a of drive shaft 12 also have a certain amount of rotational angular play—in through-holes 27 of clamping rings 14, which have larger dimensions—before they can contact inner wall 14b of through-holes 27 of clamping rings 14. Furthermore, axial extension 19 of driven shaft 13, with its pressing surfaces 29, always has clearance with cylindrical surface shells 25 of clamping rings 14. Rotational angular play therefore also exists between driven shaft 13 and clamping rings 14. This rotational angular play is designed to be somewhat greater than the rotational angular play between drive shaft 12 and clamping rings 14.

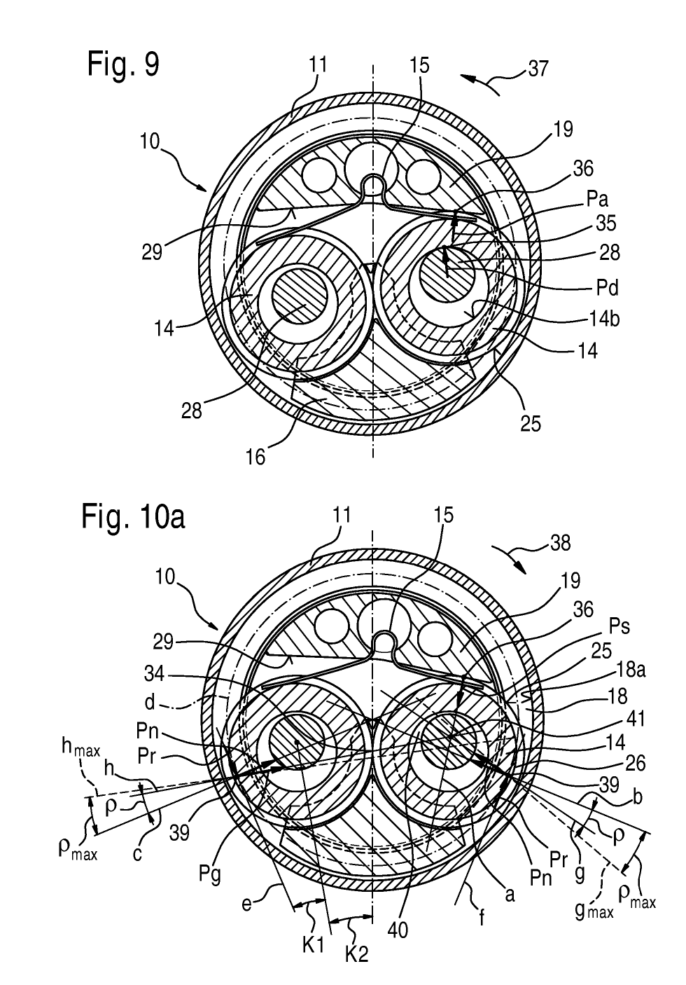

The mode of operation of load torque blocking device 10 that occurs when torque acts on the drive side to transfer a force will now be explained with reference to FIG. 9; the force is transferred from the drive side to the driven side as indicated via force direction arrows 33 in FIG. 1. According to FIG. 9, the torque to be transferred is transferred from drive shaft 12 to driven shaft 13 in the counterclockwise direction. Via the rotation of drive shaft 12, right peg-shaped projection 28 comes to bear against inner wall 14b of right clamping ring 14 at contact point 35. A rotational force Pd is produced there; it counteracts preload force Pv of spring element 15 depicted in FIG. 7 and presses right clamping ring 14 via its cylindrical surface shell 25 against right pressing surface 29 of axial extension 19 at contact point 36. Via pressure force Pa that is applied there, driven shaft 13 is now rotated with axial extension 19 inside housing opening 18 in the counterclockwise direction. Left clamping ring 14 and guide element 16 are carried along by spring element 15. Guide element 16 rests loosely via its outer guide surfaces 30 against clamping surfaces 22 of housing 11. Likewise, the two clamping rings 14 bear loosely against each other and against guide surfaces 31 of guide element 16. The entire system therefore rotates to the left in housing 11 in the direction of arrow 37 and therefore transfers the torque that is applied to drive shaft 12 to driven shaft 13 with the same rotational speed.

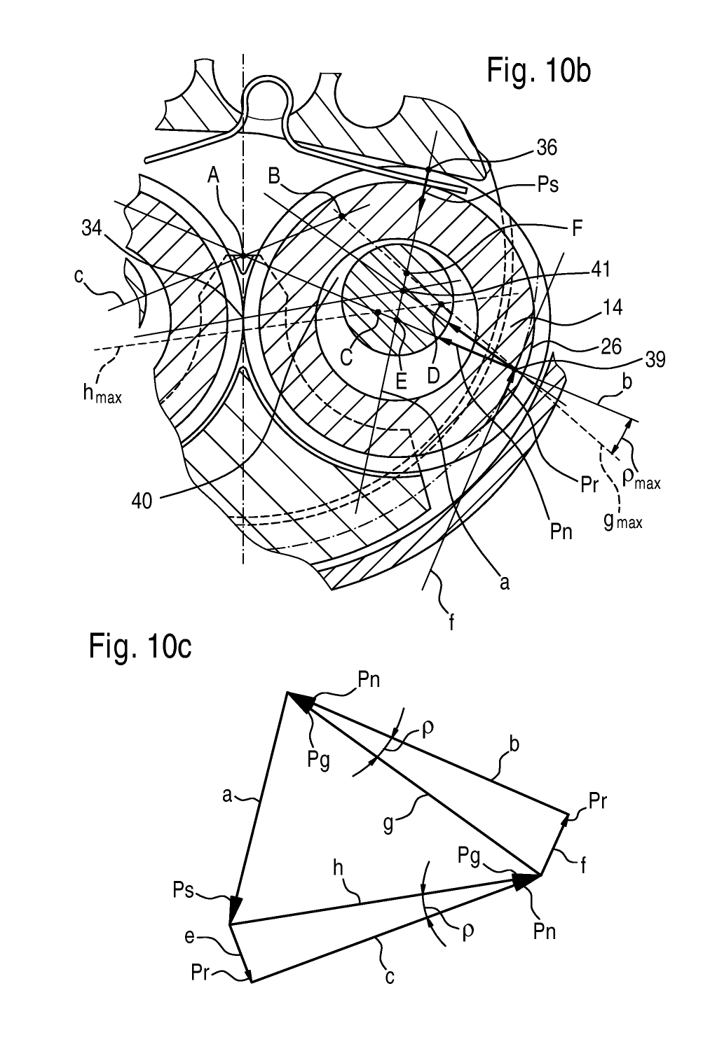

As a result of the symmetrical design of load torque blocking device 10 with the symmetrical design of the two clamping rings 14, the load torque blocking device functions in the same manner in both directions of rotation of the drive shaft and driven shaft. As a result, when a drive torque acts in the clockwise direction, the left, peg-shaped projection 28 of drive shaft 13 becomes operatively connected with left clamping ring 14 and presses it against left pressing surface 29 of axial extension 19. The system then rotates in the clockwise direction in housing 11 and transfers the drive torque to the driven side. The function of load torque blocking device 10 that occurs when a load torque is applied in the clockwise direction will now be explained with reference to FIGS. 10a through 10c. In this case, axial extension 19 is displaced in the direction of arrow 38 by the load torque acting on driven shaft 13 until its right pressing surface 29 comes to bear against cylindrical surface shell 25 of right clamping ring 14 at contact point 36. A blocking force Ps is produced there and presses right clamping ring 14 downward. Since the two clamping rings 14 bear against each other at contact point 34 with the aid of spring element 15, they are now both pressed against inner wall 18a of housing opening 18. In FIG. 10a, the relevant strain lines that occur when blocking is carried out via right clamping ring 14 are depicted graphically. Strain line a of blocking force Ps extends plumb relative to right pressing surface 29 of displaced extension 19 and through the center of right clamping ring 14. Spring element 15 is located, via its leg, in recess 26 and is therefore decoupled from the power flow via strain line a. Both of the clamping rings 14 bear via their V-shape-positioned clamping surfaces 24 against corresponding clamping surfaces 22 of housing 11. Normal forces Pn of this surface-to-surface contact, which are projected into the plane of the drawing, are located on strain lines b and c, both of which extend through the center of a clamping ring 14 and the center of housing opening 18. Friction forces Pr, which lie on tangential strain lines e and f on circumference d, oppose the efforts of the load torque to rotate the system in the right-hand direction at central circumference d—indicated by dash-dotted line—of clamping surfaces 22 and 24. Clamping rings 14 block the system from rotating by “tilting” between their contact points with housing 11, providing that sliding does not occur at their contact point 34 between the two clamping rings 14. For this type of tilting to occur, friction forces Pr that occur must be at a level that is necessary to achieve equilibrium, without exceeding their maximum level, which is determined by friction angle ζₘₐₓ. Normal forces Pn and friction forces Pr can be combined via vector addition at contact point 39 of clamping rings 14 with housing 11 to produce a total force Pg, which lies on strain lines gₘₐₓ and hₘₐₓ.

The following points about tilting are depicted graphically in FIGS. 10a through 10c. Under the load of blocking force Ps, friction forces Pr occur along strain lines e and f only to an extent that is required to achieve a state of equilibrium. The two resultant total forces Pg must establish equilibrium with blocking force Ps. To achieve mechanical moment equilibrium, strain lines h and g of total forces Pg, and strain line a of blocking force Ps must intersect at a geometric point. Reason: All three forces exist and their strain lines do not overlap, so they cannot have leverage relative to each other. This is the case only when their strain lines intersect at a point. Given the position of strain line a for blocking force Ps shown in FIG. 10a, total forces Pg—as sketched in FIG. 10a—can be located on strain lines h and g, for example. Any other angular positions of total forces Pg within a maximum friction angle ζₘₐₓ can also result in a state of equilibrium, however. Whether or not a state of equilibrium, i.e., a tilting of clamping rings 14, occurs when a load torque is produced depends on whether strain line a of blocking force Ps of extension 19 extends through surface of intersection 40—with vertices A, B, C, and D in FIG. 10b—of the two friction angles ζₘₐₓ. Reason: Surface of intersection 40 represents the sum of all geometric points in which strain lines h, g and a can intersect without infringing on either of the two friction conditions (Coulomb friction Pr<Pn×μ; that is, graphically: Strain lines h and g are within ζₘₐₓ). This is the prerequisite for attaining moment equilibrium.

In the exemplary embodiment shown in FIG. 10a, the state of equilibrium is attained by the fact that strain line a of driven-side blocking force Ps and strain lines g and h of total forces Pg intersect, e.g., at geometric point 41. The two equilibriums of forces are depicted and proven geometrically via the closed vectors of the two total forces Pg and blocking force Ps shown in FIG. 10c. As shown in FIG. 10b, any point on the line between E and F could be a point of intersection for the position of strain line a that is shown. The location of the intersection point of strain lines g, h and a on the path between E and F differs from blockage case to blockage case depending on how the friction forces are distributed at the two contact points 34 and 39, i.e., on how great the friction angle ζ that actually forms is within the possible range (0≦ζ≦ζₘₐₓ).

In contrast to normal cylindrical, free-wheeling rollers, different clamping angles K1 and K2 relative to the center of clamping rings 14 occur with current clamping rings 14, via their conical, axially symmetrical clamping surfaces 24 positioned in the shape of a V, and by the fact that they bear against each other at their cylindrical surface shells 25. The reason for this is the fact that the radii that start at the center of the clamping rings and extend to contact points 39 on housing 11, and to contact point 34, are different. If it is assumed that the friction angles 5 that occur at contact points 39 and contact point 34 are the same, the larger clamping angle of the two must be smaller than maximum friction angle ζₘₐₓ for clamping rings 14 to clamp securely. The following therefore applies:
K1<K2<ζₘₐₓ

Otherwise, clamping rings 14 would be driven by extension 19 of driven shaft 13, and they would not tilt.

It is permissible to overlook the remaining spring force of spring element 15, since it merely supports the clamping or tilting. In the manner shown, rotational motions introduced on the driven side are blocked, and driven shaft 13 is fixed in position. Likewise, drive shaft 12 is protected against driven-side torques, since they are deflected toward housing 11 and are not transferred further via projections 28 to drive shaft 12. Due to clamping surfaces 22 and 24, which are positioned relative to each other in the shape of a V, it is possible to block substantially greater torques with this load torque blocking device 10 than with cylindrical free-wheeling rollers, since a portion of the forces applied to housing 11 point in both axial directions, thereby reducing radial propagation on housing 11.

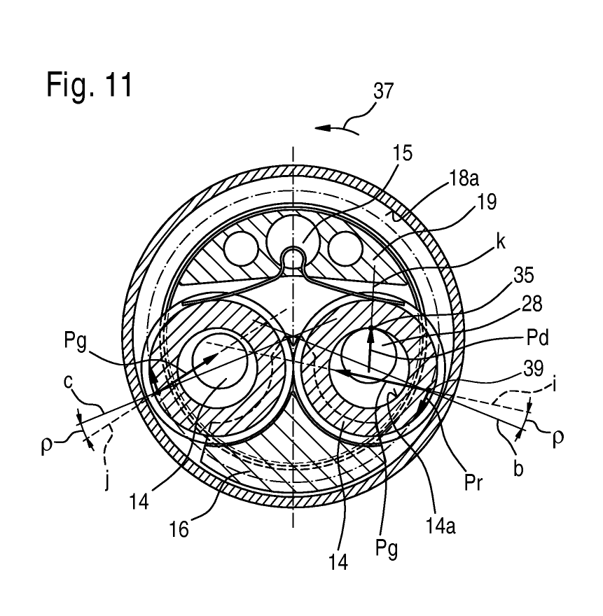

Due to the symmetrical design and positioning of the components of this load torque blocking device 10, load torques are absorbed by housing 11 in the same manner for both directions of rotation of driven shaft 13. For example, when a load torque is applied in the counterclockwise direction, axial projection 19 of driven shaft 13 presses against the left clamping ring, blocking force Ps is produced there, and the two clamping rings 14 block the rotational motion by tilting. FIG. 11 will now be referred to to describe how clamping rings 14 disengage from inner wall 18a of housing 11 when the load torque ceases. First, axial extension 19 of driven shaft 13 is rotated back by the force of spring element 15 into a neutral position in which it has approximately the same clearance from both clamping rings 14. Via the rotation of drive shaft 12 in the direction of arrow 37, both peg-shaped projections 28 of drive shaft 12 are now displaced to the point at which right projection 28 bears against inner wall 14b of right clamping ring 14. A rotational force Pd now occurs at contact point 35 and tries to raise right clamping ring 14 against the force of spring element 15. Since friction forces Pr which occur at contact points 39 of clamping rings 14 with housing 11 now have a reverse direction, the system can no longer be held in equilibrium. Strain lines i and j now result due, e.g., to friction angle ζ for total force Pg. Since these strain lines no longer intersect with strain line k of rotational force Pd at a point, the tilting of clamping rings 14 is now released. Clamping rings 14 and guide element 16 are now positioned loosely within housing opening 18 of housing 11 and are held together by spring element 15, and they are guided axially by V-shape-positioned clamping surfaces 22, 24 of housing 11 and clamping rings 14, and by guide surfaces 30 of guide element 16. As the drive-side rotation continues in the direction of arrow 37, all of the components inside the system also rotate around the longitudinal axis of housing 11. Guide element 16 supports both clamping rings 14 via the gap—which is partially filled with lubricant—between guide surfaces 30, 31 and clamping surfaces 22, 24, by way of which clamping rings 14 are prevented from wobbling around multiple axes. In this manner, a particularly quiet running is attained when torque is applied on the drive side.

To attain a compact design of load torque blocking device 10, it is essential that, when the clamping bodies are designed in the shape of clamping rings 14, open space be created for the peg-shaped projections 28 on the drive shaft. The space required for the new guide element 16 was therefore also created inside housing opening 18 at the same time. Guide element 16 with concave guide surfaces 31 relative to the two clamping rings 14 and guide surfaces 30 which are convex on the exterior relative to housing 11 make it possible to enclose clamping rings 14 in a large region when torque is applied from the drive side, and to therefore guide and support the movement of clamping rings 14. In this context, it is also important to note that V-shape-positioned clamping surfaces 22 of housing 11 greatly reduce the radial deformations that occur when clamping rings 14 are clamped, and that clamping rings 14 and guide element 16 itself are supported.

What is claimed is:

1. A load torque blocking device (10) for automatically blocking load-side torques during the drop or cessation of a drive-side torque while maintaining the capability to transfer drive-side torques from a drive shaft (12) to a driven shaft (13), comprising a housing (11) that is mounted on the frame in a fixed manner and has a central housing borehole (18), a rotatably supported drive shaft that extends, via axially protruding engaging means (28), into the housing borehole on the drive side, a rotatably supported driven shaft that extends, via an axially protruding extension (19), into the housing borehole (18) on the driven side in the circumferential region of the housing borehole in a chord-like manner, and two clamping bodies (14) that are located next to each other and eccentrically in the housing borehole, the clamping bodies (14) bearing—due to the pressing force of a spring element (15) inserted between the extension of the driven shaft and the two clamping bodies—via their outer surfaces against the inner wall of the housing borehole and against each other; the engaging means of the drive shaft release the clamping bodies from their contact with the inner wall of the housing borehole when drive-side torques are produced, and the extension of the driven shaft presses the clamping bodies against the inner wall of the housing borehole when driven-side torques are produced,
wherein
the engaging means (28) of the drive shaft (12) are two eccentrically located, preferably peg-like projections, each of which extends axially into an-opening (20) of a clamping body (14), and the opening width (W) of which is greater than the diameter (D) of the projections (28).

2. The load torque blocking device as recited in claim 1,
wherein
the clamping bodies (14) are designed as clamping rings, into each of the through-holes (20) of which one of the two projections (28) of the drive shaft (12) extends with rotational angular play.

3. The load torque blocking device as recited in claim 2,
wherein
the inner wall (18a) of the housing borehole (18) and the outer wall (14a) of the two clamping rings (14) each have at least one pair of adjacently located, conically extending clamping surfaces (22, 24) that are positioned relative to each other in the shape of a V.

4. The load torque blocking device as recited in claim 3,
wherein
the clamping surfaces (22, 24) that are positioned relative to each other in the shape of a V are separated from each other by an axial circumferential surface, particularly a cylindrical surface shell (23, 25).

5. The load torque blocking device as recited in claim 4,
wherein
the clamping rings (14) have a groove-shaped recess (26) on the outer circumference, in the region of their cylindrical surface shell (24), into which a leg (15b) of the two-legged spring element (15) inserted between the extension (19) of the driven shaft (13) and the clamping rings (14) engages with no radial clearance.

6. The load torque blocking device as recited in claim 5,
wherein
the extension (19) of the driven shaft (13)—which is positioned in the circumferential region of the housing borehole (18) in a chord-like manner—includes at least one axial through-hole (20a), and, preferably, several adjacently located through-holes (20), some of which contain lubricant; the central borehole (20a) is provided with a radially inwardly pointing opening (21) into which an eyelet-shaped, central section (15a) of the spring element (15) is displaceably accommodated.

7. The load torque blocking device as recited in claim 2,
wherein
a guide element (16) is loosely positioned in the housing borehole (18) on the side opposite to the extension (19) of the driven shaft (13) and bears against the inner wall (18a) of the housing borehole (18) and the outer walls (14a) of the two clamping rings (14).

8. The load torque blocking device as recited in claim 7,
wherein the guide element (16) has a triangular contour, and it lies flat—via a convex outer side (16a)—against the inner wall (18a) of the housing, and flat—via two symmetrical, concave inner sides (16b) that point toward the housing center—against the outer walls (14a) of the two clamping rings (14).

9. The load torque blocking device as recited in claim 8,
wherein
the convex outer side (16b) of the guide element (16) includes guide surfaces (30) that are positioned relative to each other such that they form a V, are matched to the clamping surfaces (22) of the housing inner wall (18a), and have an intermediate cylindrical section (30a), and wherein the two concave inner sides (16b) each have guide surfaces (31) that are positioned relative to each other such that they form a V, are matched to the clamping surfaces (24) of the clamping rings (14), and have an intermediate cylindrical section (31a).

10. The load torque blocking device as recited in claim 9,
wherein
the concave guide surfaces (31) of the guide element (16) extend past the region of the contact point (34) of the clamping rings (14) and include, in this region, a connecting window (32), in which the two clamping rings (14) bear against each other.
